(19) United States
(12) Patent Application Publication
(10) Pub. No.: US 2009/0207358 A1
(43) Pub. Date: Aug. 20, 2009

(54) HORIZONTAL-SWITCHING FLEXIBLE LIQUID CRYSTAL DISPLAYS AND FABRICATION METHODS THEREOF

(75) Inventors: Kuo-Chang Lee, Pingtung County (TW); Kuo-Lung Lo, Taipei County (TW); Yi-An Sha, Taipei City (TW)

Correspondence Address: QUINTERO LAW OFFICE, PC, 2210 MAIN STREET, SUITE 200, SANTA MONICA, CA, 90405, US

(73) Assignee: INDUSTRIAL TEACHNOLOGY RESEARCH INSTITUTE, HSINCHU (TW)

(21) Appl. No.: 12/233,558

(22) Filed: Sep. 18, 2008

(30) Foreign Application Priority Data
Feb. 14, 2008 (TW) TW097105135

(51) Int. Cl. G02F 1/1337; G02F 1/1343

(52) U.S. Cl. 349/128; 349/146

(57) ABSTRACT

Horizontal-switching flexible liquid crystal displays (LCD) and fabrication methods thereof are provided. The horizontal-switching flexible liquid crystal display includes a flexible first substrate, a second substrate and a liquid crystal (LC) layer interposed therebetween. The LC layer consists of liquid crystal molecules affected by a horizontal field and divided into an upper portion and a lower portion. At least one pair of a patterned pixel electrode and a common electrode is disposed on the first substrate. The pixel electrode and the common electrode are formed on the same plane, thereby generating a horizontal field during operation. First and second alignment layers allow the LC molecules of the LC layer to be in a substantially vertical alignment. The phase retardation of the horizontal-switching LCD is due to the lower portion of the LC layer.

### CROSS-REFERENCE TO RELATED APPLICATIONS

This application is based upon and claims the benefit of priority from a prior Taiwanese Patent Application No. 097105135, filed on Feb. 14, 2008, the entire contents of which are incorporated herein by reference.

### BACKGROUND OF THE INVENTION

1. Field of the Invention

The invention relates to liquid crystal display devices and fabrication methods thereof, and more particularly to horizontal-switching flexible liquid crystal displays and fabrication methods thereof.

2. Description of the Related Art

Liquid crystal display (LCD) devices have several advantages over other display technologies, such as a smaller volume, a lighter weight, and lower power consumption. As such, LCD devices are being applied in a variety of electronic and communication devices including notebook computers, personal digital assistants (PDA), mobile phones and others. Given the trends, technological development of LCD devices are now focusing on lighter and thinner profiles with increased portability.

Limitations of conventional flexible LCD devices are due to uneven deformation of a liquid crystal cell gap. When display regions are affected by applied force causing the LCD to bend, it becomes difficult for the gap of the LC cell to maintain a desirable distance. As such, phase retardation and phase difference of passing light are negatively affected, thus deteriorating display quality of conventional flexible LCD devices.

In order to solve the abovementioned problems such as applied force and retardation due to bending, U.S. Pat. No. 5,699,139, the entirety of which is hereby incorporated by reference, discloses an LCD device forming stress released structures on the edges of the display panel to release stress generated during bending of the substrate.

FIG. 1 is a cross section of a conventional LCD device with stress release structures thereon. Referring to FIG. 1, a conventional LCD device includes a first substrate 14 and a second substrate 12 opposing to each other. A liquid crystal layer 22 is sandwiched between the first and second substrates with a gap fixed by spacers 18. The LCD device may be divided into an active region 20 and a stress released region 30. The first substrate 14 at the stress released region 30 has a thinned region 40 with recesses 42, 44 respectively on top and bottom surfaces thereof Stress due to applied force on the LCD device is released by deforming the recesses 42 and 44. For example, when the length of the active region 20 is “d”, the length of the stress released region 30 is “2θ”, the thickness of the thinned region 40 is “tᵣ”, and the cell gap of the LC layer at the stress released region 30 is “f”, the LCD device can be effectively protected from applied force.

U.S. Pub. No. 2003/0137630, the entirety of which is hereby incorporated by reference, discloses an LCD device with a trench formed at a peripheral region of the panel. The stress is absorbed to effectively prevent variation of the LC gap. FIG. 2 is a cross section of another conventional LCD device with trenches on a peripheral region. Referring to FIG. 2, the conventional LCD device with trenches includes a first substrate 52 and a second substrate 51a opposing to each other. A specific gap is created between the first and second substrates, and a liquid crystal layer therebetween is sealed by a sealer element 57. The first substrate 52 is a glass substrate. The second substrate 51a is a flexible substrate. A thermoset resin is formed outside of the sealer element 57 to define a display region. An external circuitry 59 is disposed on the first substrate 52 outside of the display region. Stress absorbable trenches 58 are respectively disposed on the surfaces of the first substrate 52 and the second substrate 51a of the conventional LCD device to prevent gap variation of the LC layer.

Further, U.S. Pub. No. 2006/0204675, the entirety of which is hereby incorporated by reference, discloses a flexible LCD device. A rigid display region and a flexible bending buffer region are formed on a flexible substrate. When the substrate is bended, stress and strain are mainly concentrated on the flexible bending buffer region to prevent the rigid display region from deformation. FIG. 3A is a cross section of a conventional flexible LCD device. FIG. 3B is a plan view of the flexible LCD device of FIG. 3A. Referring to FIGS. 3A and 3B, a flexible LCD device includes an array of display pixels 75. Signal lines 65 are connected among each of the display pixels 75. Both the display pixels 75 and signal lines 65 are formed on a carrier substrate which includes a rigid region 70 and a flexible region 60. When the substrate is bended, stress and strain are mainly concentrated on the flexible region to prevent gap variation of the LC layer.

The conventional methods and structure for releasing stress on the flexible substrate, however, can affect structural strength. In addition, a complex and tedious fabrication process is also required, increasing production costs. Thus, flexible LCD devices, whereby LC layer gap is not affected by applied stress and the structural strength of the substrate remains unchanged, are eagerly desired.

### BRIEF SUMMARY OF THE INVENTION

Embodiments of the invention provide horizontal-switching flexible liquid crystal display devices. Orientations of the liquid crystal molecules (i.e., by designing more stable liquid crystal orientations) are changed so that the liquid crystal gap and phase retardation of the LC layer remain unchanged as the substrate is bended.

An exemplary embodiment of the invention provides a horizontal-switching flexible liquid crystal display (LCD) device, comprising: a first substrate and a second substrate opposing to each other with a liquid crystal (LC) layer interposed therebetween, wherein the LC layer is affected by a horizontal field and divided into an upper portion and a lower portion; at least one pair of a patterned pixel electrode and a common electrode, disposed on the first substrate, wherein the pixel electrode and the common electrode are formed on the same plane, thereby generating a horizontal field during operation; a first alignment layer disposed on the first substrate covering the pixel electrode and the common electrode; and a second alignment layer disposed on the second substrate, wherein the first and second alignment layers allow the LC molecules of the LC layer to be in a substantially vertical alignment, and wherein the phase retardation of the horizontal-switching LCD is due to the lower portion of the LC layer.

Another exemplary embodiment of the invention provides a horizontal-switching flexible liquid crystal display (LCD) device, comprising: a first substrate and a second substrate opposing to each other with a liquid crystal (LC) layer interposed therebetween, wherein the LC layer is affected by a horizontal field and divided into an upper portion and a lower portion; a common electrode disposed on the first substrate; a dielectric layer disposed on the common electrode; a patterned pixel electrode disposed on the dielectric layer, wherein the pixel electrode and the common electrode are located at different planes, thereby generating a fringe field during operation; a first alignment layer disposed on the first substrate covering the pixel electrode and the common electrode; and a second alignment layer disposed on the second substrate, wherein the first and second alignment layers allow the LC molecules of the LC layer to be in a substantially vertical alignment, and wherein the phase retardation of the horizontal-switching LCD is due to the lower portion of the LC layer.

An exemplary embodiment of the invention provides a fabrication method for a horizontal-switching flexible liquid crystal display (LCD) device, comprising: forming at least one pair of a patterned pixel electrode and a common electrode on a first substrate, wherein the pixel electrode and the common electrode are formed on the same plane; forming a first alignment layer on the first substrate covering the pixel electrode and the common electrode; forming a second alignment layer on the second substrate, wherein the first alignment layer and the second alignment layer are rubbed along an oriented direction, and an included angle between the rubbed oriented direction and the first and the second alignment layers is substantially perpendicular; assembling the first substrate and the second substrate; filling a liquid crystal layer between the first substrate and the second substrate; and sealing the liquid crystal layer.

Another exemplary embodiment of the invention provides a fabrication method for a horizontal-switching flexible liquid crystal display (LCD) device, comprising: providing a first substrate; forming an entire common electrode on the first substrate; forming a dielectric layer on the common electrode; forming a patterned pixel electrode on the dielectric layer, wherein the pixel electrode and the common electrode are formed at different planes; forming a first alignment layer on the first substrate covering the pixel electrode and the common electrode; forming a second alignment layer on the second substrate, wherein the first alignment layer and the second alignment layer are rubbed along an oriented direction, and an included angle between the rubbed oriented direction and the first and the second alignment layers is substantially perpendicular; assembling the first substrate and the second substrate; filling a liquid crystal layer between the first substrate and the second substrate; and sealing the liquid crystal layer.

### BRIEF DESCRIPTION OF THE DRAWINGS

The invention can be more fully understood by reading the subsequent detailed description and examples with references made to the accompanying drawings, wherein:

FIG. 1 is a cross section of a conventional LCD device with stress release structures thereon;

FIG. 2 is a cross section of another conventional LCD device with trenches on a peripheral region;

FIG. 3A is a cross section of a conventional flexible LCD device;

FIG. 3B is a plan view of the flexible LCD device of FIG. 3A;

FIGS. 4A and 4B are cross sections of a conventional twisted nematic (TN) LCD device, wherein FIG. 4A shows LC configuration at a voltage off-state, and FIG. 4A shows LC configuration at a voltage on-state;

FIG. 5 is a cross section schematically showing an embodiment of a horizontal-switching flexible LCD device;

FIG. 6 is a cross section schematically showing another embodiment of the horizontal-switching flexible LCD device;

FIG. 7 is a cross section schematically showing yet another embodiment of the horizontal-switching flexible LCD device;

FIG. 8 shows simulated results of optical characteristics of the conventional TN-LCD devices; and

FIG. 9 shows simulated results of optical characteristics of the horizontal-switching LCD devices.

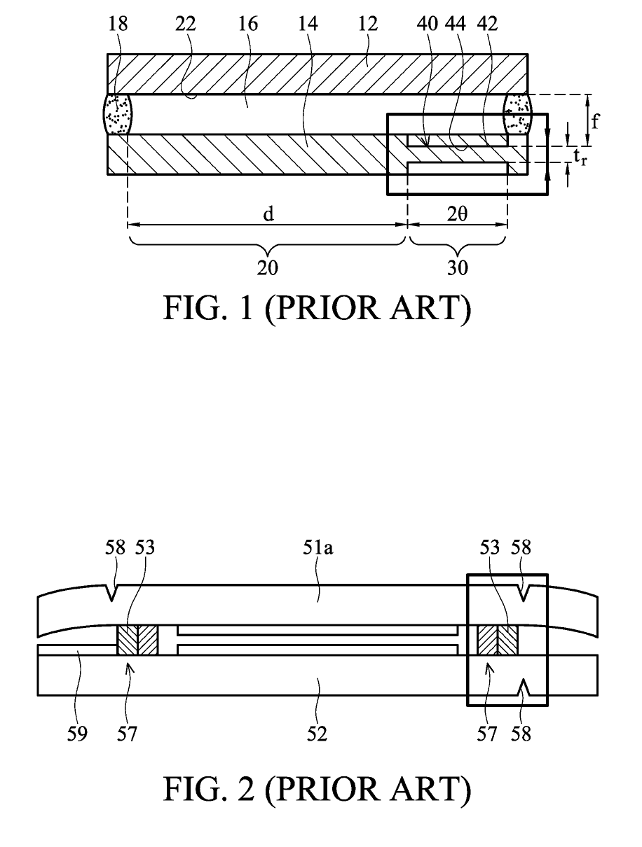

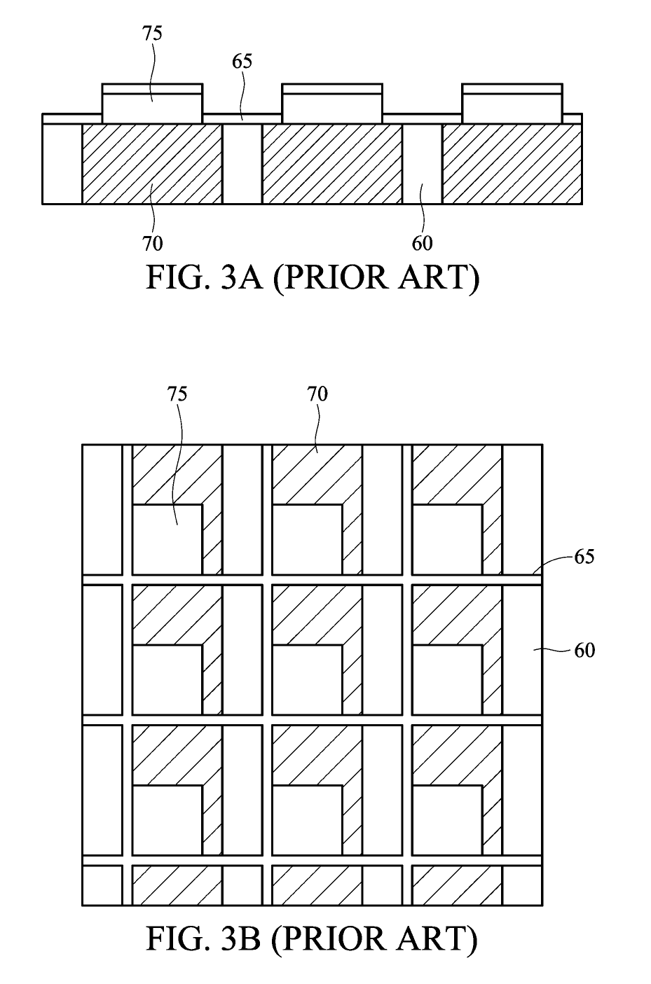

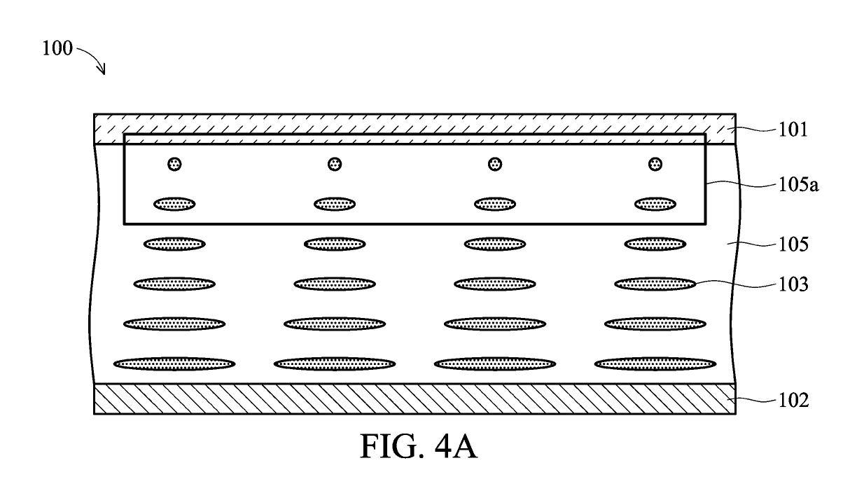

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide flexible LCD structures. Using specific orientation of liquid crystal molecules configured with a special electrode structural design, the liquid crystal layer gap of the embodiments of the invention has changed, while the phase retardation remains stable, thus maintaining stable optical performances as the display panel is bended. Specifically, a predetermined mode of liquid crystal orientations is used to fabricate an LCD device which is less sensitive to LC cell gap variations. Thus, phase retardation of passing light through the LC layer is not affected, thereby maintaining stable optical performance.

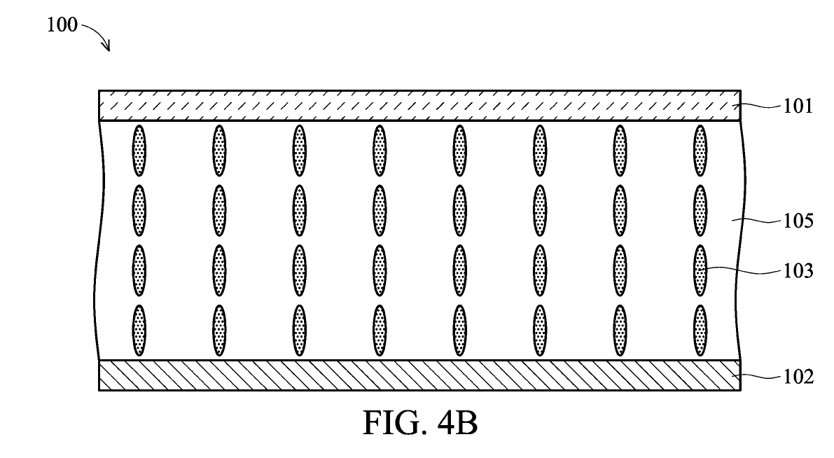

FIGS. 4A and 4B are cross sections of a conventional twisted nematic (TN) LCD device, wherein FIG. 4A shows LC configuration at a voltage off-state, and FIG. 4B shows LC configuration at a voltage on-state. Referring to FIG. 4A, a conventional TN-LCD device 100 includes a first substrate (e.g., a lower substrate) 102 and a second substrate (e.g., an upper substrate) 101 opposing to each other. A liquid crystal layer 105 is disposed between the first and the second substrates. The liquid crystal layer 105 includes liquid crystal molecules 103. At a display off-state, the LCD device 100 is unaffected by an electric field. Referring to FIG. 4B, when the liquid crystal layer 105 is biased by a vertical electric field, the LCD device 100 displays an on-state. Liquid crystal molecules 103 are arranged along the direction vertical to the upper and lower substrates. When the LCD panel 100 is deformed by an applied force, the LC molecules at an upper region 105a of the liquid crystal layer 105 primarily contribute to phase retardation of the LCD device. The LC cell gap varies due to deformation of the second substrate (upper substrate) such that different phase retardations are presented in the upper region 105a at the on-state and off-state, respectively.

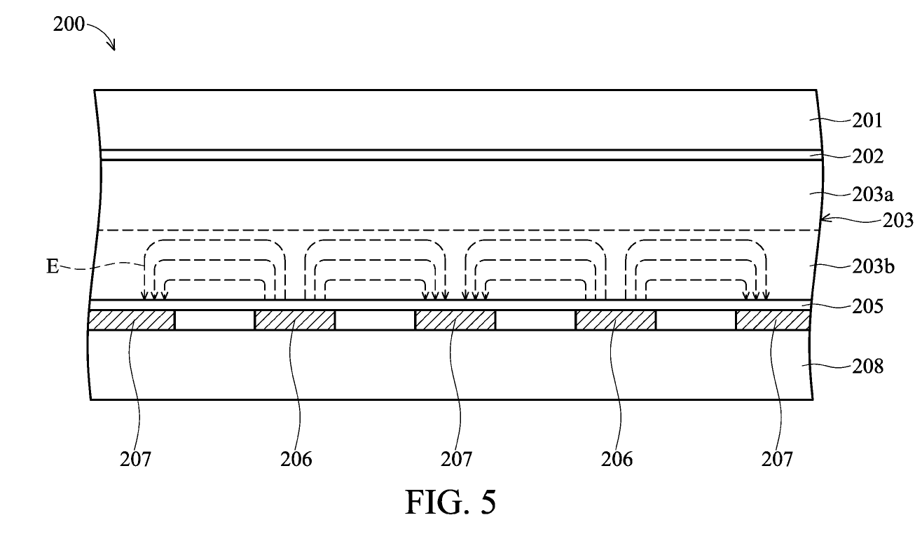

FIG. 5 is a cross section schematically showing an embodiment of a horizontal-switching flexible LCD device. Referring to FIG. 5, a horizontal-switching LCD device 200 such as an In-Plane Switching Liquid Crystal Display (IPS-LCD) device includes a first substrate (e.g., a lower substrate) 208 and a flexible second substrate (e.g., an upper substrate) 201 opposing to each other. A liquid crystal layer 203 is disposed between the first and the second substrates. The liquid crystal layer 203 includes liquid crystal molecules which are divided into an upper region 203a and a lower region 203b by a horizontal electric field during operation. At least one pair of a patterned pixel electrodes 206 and common electrodes 207 are disposed on the first substrate 208. Both the pixel and common electrodes are disposed on the same substrate. The pixel electrodes 206 and the common electrodes 207 are positioned at the same level, thereby creating a horizontal electric field E during operation. A first alignment layer 205 is disposed on the first substrate 208 covering the pixel electrodes 206 and the common electrodes 207.

A second alignment layer 202 is disposed on the second substrate 201, wherein the first alignment layer 205 and the second alignment layer 202 allow LC molecules of the LC layer to be in a substantially vertical alignment. The driving electric field E of the horizontal-switching flexible LCD device is primarily distributed in the lower region 203b of LC layer from the pixel electrode 206 to the common electrode 207. Moreover, since the phase retardation of the horizontal-switching LCD is due to the lower portion 203b of the LC layer, phase and retardation of the lower portion 203b of the LC layer remain constant even if the LC cell gap varies due to deformation of the second substrate (upper substrate) 201.

One of the first substrate 208 and the second substrate 201 can be a flexible substrate. For example, the second substrate 201 is a flexible substrate including a polycarbonate (PC) substrate, a polyethersulfone (PES) substrate, a polyethylene terephthalate (PET) substrate, a polyimide (PI) substrate, a p-nitrophenylbutyrate (PNB) substrate, a polyetheretherketone (PEEK) substrate, a polyethylenenaphthalate (PEN) substrate, a polyetherimide (PEI) substrate, or a polyacrylate (PAR) substrate. Alternatively, both the first substrate and the second substrate can be flexible. According to an embodiment of the invention, the upper substrate is adapted to a flexible substrate such that deformation occurs at one side of the LCD panel. Since phase retardation is contributed from the other side of the LCD panel, the entity of the phase retardation remains constant regardless of variation of the LC cell gap, i.e., optical performance of the LCD device is unaffected.

The first substrate 208 can be an active matrix substrate including an array of active devices (not shown) corresponding to each pixel of the horizontal-switching LCD device 200. The second substrate 201 can be a color filter (CF) substrate, including color filter structures and a black matrix among the color filter structures. The shape of the pixel electrode 206 can be striped, square, zigzagged, serpentine, polygonal, or circular. Similarly, the shape of the common electrode 207 can be striped, square, zigzagged, serpentine, polygonal, or circular.

According to another embodiment of the invention, the first alignment layer 205 and the second alignment layer 202 are separately performed a rubbing procedure, such that liquid crystal molecules in the LC layer are substantially vertically oriented. For example, the liquid crystal molecules in the LC layer are respectively aligned to the first alignment layer and the second alignment layer in a range of about 90°±15°.

In referring to FIG. 5, the fabrication method for the horizontal-switching flexible LCD device 200 includes forming at least one patterned pixel electrodes and common electrodes on the first substrate, wherein the pixel electrodes and the common electrodes are disposed on the same level and both the pixel and common electrodes are disposed on the same substrate. According to an embodiment of the invention, the covering region of the common electrode exceeds or equals to that of the pixel electrode. Next, a first alignment layer is formed on the first substrate covering the pixel electrode and the common electrode. A second alignment layer is formed on a flexible substrate. The first alignment layer 205 and the second alignment layer 202 are separately performed a rubbing procedure such that the liquid crystal molecules in the LC layer are substantially vertically aligned to the first alignment layer and the second alignment layer. Subsequently, the first substrate and the second substrate are oppositely assembled. A liquid crystal layer is filled between the first and the second substrates and is sequentially sealed.

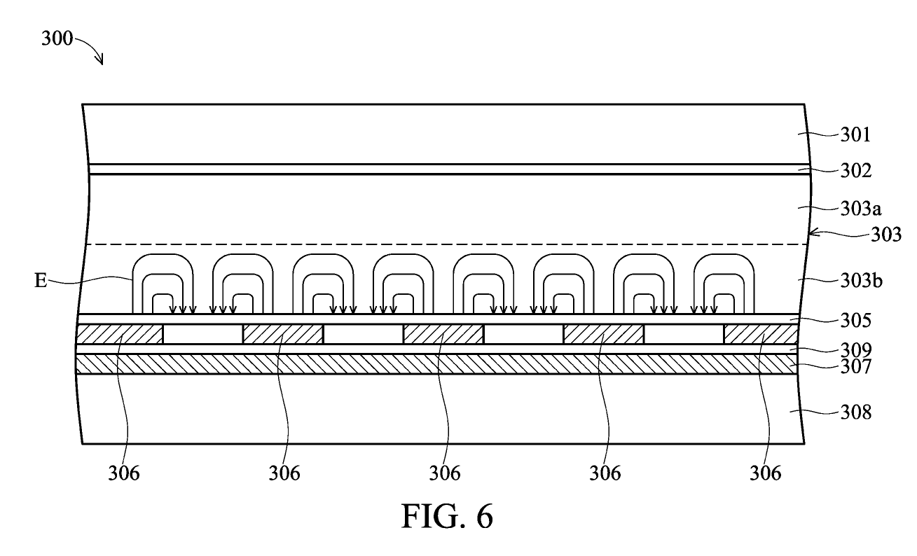

FIG. 6 is a cross section schematically showing another embodiment of the horizontal-switching flexible LCD device. Referring to FIG. 6, a horizontal-switching LCD device 300 such as a Fringe Field Switching Liquid Crystal Display (FFS-LCD) device includes a first substrate (e.g., a lower substrate) 308 and a flexible second substrate (e.g., an upper substrate) 301 opposing to each other. A liquid crystal layer 303 is disposed between the first and the second substrates. The liquid crystal layer 303 includes liquid crystal molecules which are divided into an upper region 303a and a lower region 303b by a horizontal electric field during operation. A common electrode 307 is completely disposed covering the entire region of the first substrate 308. A dielectric layer 309 is disposed on the common electrode 307. A patterned pixel electrode 306 is disposed on the dielectric layer 309. The pixel electrode 306 and the common electrode 307 are respectively positioned on different levels, thereby creating a fringe electric field E during operation. The indication of the fringe electric field E is from the pixel electrode 306 to the common electrode 307 and is in principle, distributed in the lower region 303b of the LC layer. Since phase retardation is contributed from the lower region 303b of the LC layer, the phase difference and the phase retardation remain constant even if the LC cell gap varies due to deformation of the second substrate (upper substrate) 301.

A first alignment layer 305 is disposed on the first substrate 308 covering the pixel electrode 306, and a second alignment layer 302 is disposed on the second substrate 301. The first alignment layer 305 and the second alignment layer 302 are separately performed a rubbing procedure such that liquid crystal molecules in the LC layer are substantially vertically oriented. For example, the liquid crystal molecules in the LC layer are respectively aligned to the first alignment layer and the second alignment layer in a range of about 90°±15°.

One of the first substrate 308 and the second substrate 301 can be a flexible substrate. Alternatively, both the first substrate and the second substrate can be flexible. The first substrate 308 can be an active matrix substrate including an array of active devices (not shown) corresponding to each pixel of the horizontal-switching LCD device 300. The second substrate 301 can be a color filter (CF) substrate, including color filter structures and a black matrix among the color filter structures. The shape of the pixel electrode 306 can be striped, square, zigzagged, serpentine, polygonal, or circular.

In referring to FIG. 6, the fabrication method for the horizontal-switching flexible LCD device 300 includes providing a first substrate. A common electrode is completely formed on the entire region of the first substrate. A dielectric layer is formed on the common electrode. Patterned pixel electrodes are formed on the dielectric layer, wherein the pixel electrodes and the common electrode are disposed on different levels. Next, a first alignment layer is formed on the first substrate covering the pixel electrodes. A second alignment layer is formed on the second substrate. The first alignment layer and the second alignment layer are separately performed a rubbing procedure such that liquid crystal molecules in the LC layer are substantially vertically aligned to the first alignment layer and the second alignment layer. Subsequently, the first substrate and the second substrate are oppositely assembled. A liquid crystal layer is filled between the first and the second substrates and is sequentially sealed.

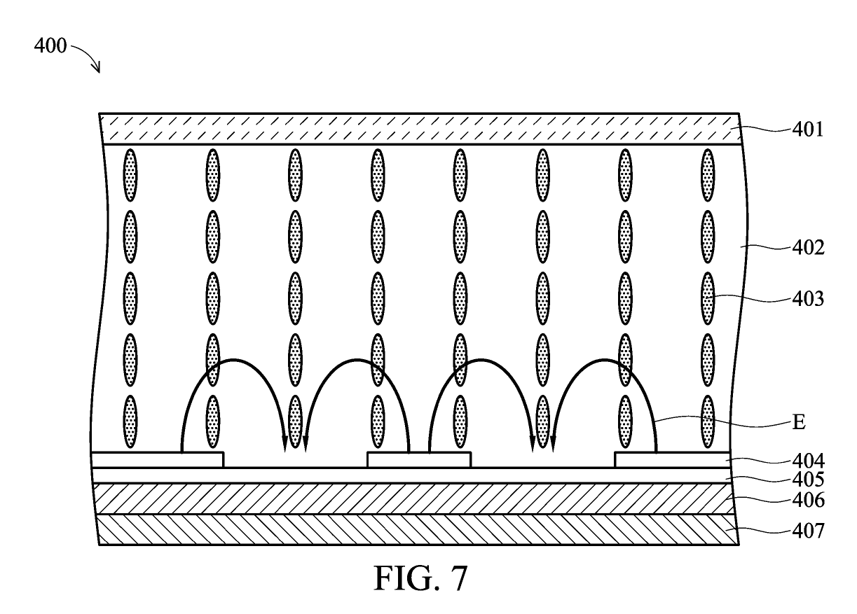

FIG. 7 is a cross section schematically showing yet another embodiment of the horizontal-switching flexible LCD device. Referring to FIG. 7, a horizontal-switching flexible LCD device 400 comprises pixel electrodes 404 with rectangular (striped) structures and an entirely blanketed common electrode 406. A dielectric layer 405 is interposed between the pixel electrode 404 and the common electrode 406. The line width of the striped pixel electrodes 404 is 10 μm, and the interval between the striped pixel electrodes is 404 μm. The cell gap of the LC layer is 4 μm. The dielectric layer 405 can be made of silicon oxide (SiOₓ) with a thickness about 1000 Å.

One or both of the first substrate 407 and the second substrate 401 can be a flexible substrate. For example, the second substrate 401 is a flexible substrate including a polycarbonate (PC) substrate, a polyethersulfone (PES) substrate, a polyethylene terephthalate (PET) substrate, a polyimide (PI) substrate, a p-nitrophenylbutyrate (PNB) substrate, a polyetheretherketone (PEEK) substrate, a polyethylenenaphthalate (PEN) substrate, a polyetherimide (PEI) substrate, or a polyacrylate (PAR) substrate.

Note that there are additional structural elements and fabrication steps not mentioned here, which are required to complete the horizontal-switching LCD device, but which are not essential to an understanding of the invention. For simplicity, detailed description is omitted.

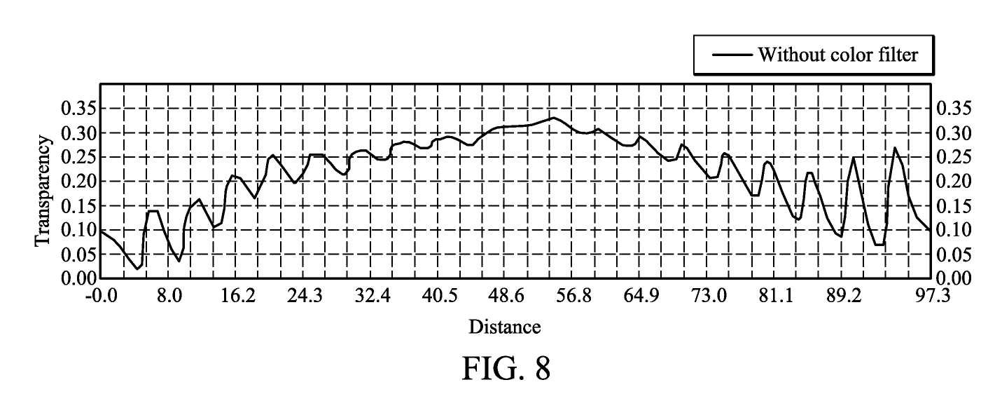

FIG. 8 shows simulated results of optical characteristics of the conventional TN-LCD devices. The relationship between transmission and transverse distance of the LCD device during operation is shown in FIG. 8. When the cell gap of the LC layer deforms from 4 μm to 5 μm, transmission variation of the TN-LCD device represents that the liquid crystal molecule distribution results in unstable optical performances due to deformation of the substrate.

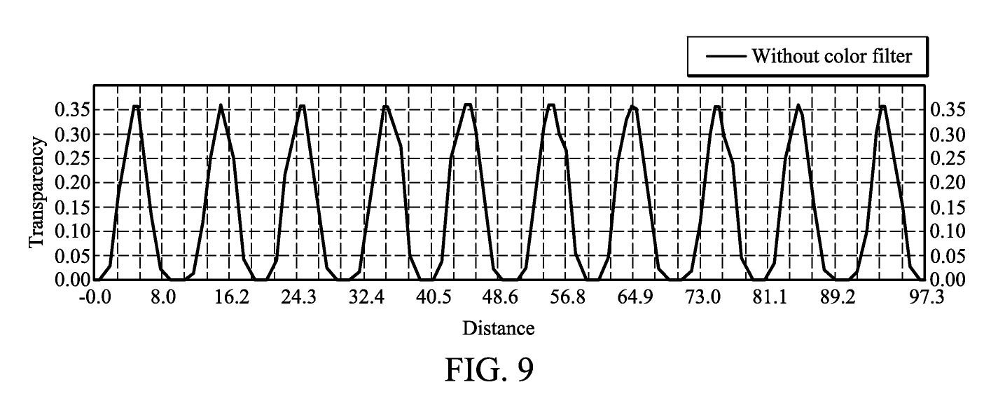

FIG. 9 shows simulated results of optical characteristics of the horizontal-switching LCD devices. Transmission variation along transverse distance of the horizontal-switching LCD device is shown in FIG. 9. When the cell gap of the LC layer deforms from 4 μm to 5 μm, transmission of the horizontal-switching LCD device remains unchanged, which means that the liquid crystal molecule distribution results in stable optical performances regardless of the cell gap deformation of the LC layer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A horizontal-switching flexible liquid crystal display (LCD) device, comprising:
a first substrate and a second substrate opposing to each other with a liquid crystal (LC) layer interposed therebetween, wherein the LC layer is affected by a horizontal field and divided into an upper portion and a lower portion;
at least one pair of a patterned pixel electrode and a common electrode disposed on the first substrate, wherein the pixel electrode and the common electrode are formed on the same plane, thereby generating a horizontal field during operation;
a first alignment layer disposed on the first substrate covering the pixel electrode and the common electrode; and
a second alignment layer disposed on the second substrate,
wherein the first and second alignment layers allow the LC molecules of the LC layer to be in a substantially vertical alignment; and
wherein the phase retardation of the horizontal-switching flexible LCD is due to the lower portion of the LC layer.

2. The horizontal-switching flexible LCD device as claimed in claim 1, wherein at least one of the first substrate or the second substrate is a flexible substrate.

3. The horizontal-switching flexible LCD device as claimed in claim 1, wherein the second substrate is an active matrix array substrate.

4. The horizontal-switching flexible LCD device as claimed in claim 1, wherein the first substrate is a color filter substrate.

5. The horizontal-switching flexible LCD device as claimed in claim 4, wherein the color filter substrate comprises a plurality of color filter structures and a black matrix among the plurality of color filter structures.

6. The horizontal-switching flexible LCD device as claimed in claim 1, wherein the shape of the pixel electrode comprises a striped, square, zigzagged, serpentine, polygonal, or circular.

7. The horizontal-switching flexible LCD device as claimed in claim 1, wherein the shape of the common electrode comprises a striped, square, zigzagged, serpentine, polygonal, or circular.

8. The horizontal-switching flexible LCD device as claimed in claim 1, wherein a projection area of the common electrode is greater than or equal to an area of the pixel electrode.

9. The horizontal-switching flexible LCD device as claimed in claim 1, wherein the first alignment layer and the second alignment layer are rubbed along an oriented direction, and an included angle between the rubbed oriented direction and the first and the second alignment layers is in a range of about 90°±15°.

10. A horizontal-switching flexible liquid crystal display (LCD) device, comprising:
a first substrate and a second substrate opposing to each other with a liquid crystal (LC) layer interposed therebetween, wherein the LC layer is affected by a horizontal field and divided into an upper portion and a lower portion;
a common electrode disposed on the first substrate;
a dielectric layer disposed on the common electrode;
a patterned pixel electrode disposed on the dielectric layer, wherein the pixel electrode and the common electrode are located at different planes, thereby generating a fringe field during operation;
a first alignment layer disposed on the first substrate covering the pixel electrode and the common electrode; and
a second alignment layer disposed on the second substrate,
wherein the first and second alignment layers allow the LC molecules of the LC layer to be in a substantially vertical alignment; and
wherein the phase retardation of the horizontal-switching flexible LCD is due to the lower portion of the LC layer.

11. The horizontal-switching flexible LCD device as claimed in claim 10, wherein at least one of the first substrate or the second substrate is a flexible substrate.

12. The horizontal-switching flexible LCD device as claimed in claim 10, wherein the second substrate is an active matrix array substrate.

13. The horizontal-switching flexible LCD device as claimed in claim 10, wherein the first substrate is a color filter substrate.

14. The horizontal-switching flexible LCD device as claimed in claim 13, wherein the color filter substrate comprises a plurality of color filter structures and a black matrix among the plurality of color filter structures.

15. The horizontal-switching flexible LCD device as claimed in claim 10, wherein the shape of the pixel electrode comprises a striped, square, zigzagged, serpentine, polygonal, or circular.

16. The horizontal-switching flexible LCD device as claimed in claim 10, wherein a projection area of the common electrode is greater than or equal to an area of the pixel electrode.

17. The horizontal-switching flexible LCD device as claimed in claim 10, wherein the first alignment layer and the second alignment layer are rubbed along an oriented direction, and an included angle between the rubbed oriented direction and the first and the second alignment layers is in a range of about 90°±15°.

18. A fabrication method for a horizontal-switching flexible liquid crystal display (LCD) device, comprising:
forming at least one pair of a patterned pixel electrode and a common electrode on a first substrate, wherein the pixel electrode and the common electrode are formed on the same plane;
forming a first alignment layer on the first substrate covering the pixel electrode and the common electrode;
forming a second alignment layer on the second substrate, wherein the first alignment layer and the second alignment layer are rubbed along an oriented direction, and an included angle between the rubbed oriented direction and the first and the second alignment layers is substantially perpendicular;
assembling the first substrate and the second substrate;
filling a liquid crystal layer between the first substrate and the second substrate; and
sealing the liquid crystal layer.

19. The fabrication method as claimed in claim 18, wherein at least one of the first substrate or the second substrate is a flexible substrate.

20. The fabrication method as claimed in claim 18, wherein the first substrate is a color filter substrate with a plurality of color filter structures and a black matrix among the plurality of color filter structures.

21. The fabrication method as claimed in claim 18, wherein the shape of the pixel electrode comprises a striped, square, zigzagged, serpentine, polygonal, or circular.

22. The fabrication method as claimed in claim 18, wherein the shape of the common electrode comprises a striped, square, zigzagged, serpentine, polygonal, or circular.

23. A fabrication method for a horizontal-switching flexible liquid crystal display (LCD) device, comprising:
providing a first substrate;
forming an entire common electrode on the first substrate;
forming a dielectric layer on the common electrode;
forming a patterned pixel electrode on the dielectric layer, wherein the pixel electrode and the common electrode are formed at different planes;
forming a first alignment layer on the first substrate covering the pixel electrode and the common electrode;
forming a second alignment layer on the second substrate, wherein the first alignment layer and the second alignment layer are rubbed along an oriented direction, and an included angle between the rubbed oriented direction and the first and the second alignment layers is substantially perpendicular;
assembling the first substrate and the second substrate;
filling a liquid crystal layer between the first substrate and the second substrate; and
sealing the liquid crystal layer.
